(19) United States
(12) Patent Application Publication
(10) Pub. No.: US 2026/0220893 A1
(43) Pub. Date: Jul. 30, 2026

(54) METHOD, APPARATUS, ELECTRONIC DEVICE, AND STORAGE MEDIUM FOR GENERATING LEVELS-OF-DETAIL MODELS

(71) Applicant: Realsee (Beijing) Technology Co., Ltd., Beijing (CN)

(72) Inventors: Yang HU, Beijing (CN); Mofang CHENG, Beijing (CN); Wei LIU, Beijing (CN)

(73) Assignee: Realsee (Beijing) Technology Co., Ltd., Beijing (CN)

(21) Appl. No.: 19/144,049

(22) PCT Filed: Dec. 22, 2023
(86) PCT No.: PCT/CN2023/141169

§ 371 Date: Jun. 27, 2025

(30) Foreign Application Priority Data
Dec. 29, 2022 (CN) 202211700543.5

(51) Int. Cl. G06T 17/20; G06T 15/04

(52) U.S. Cl. CPC G06T 17/205; G06T 15/04; G06T 2210/36

(57) ABSTRACT

Embodiments of the present disclosure disclose a method, apparatus, electronic device, and storage medium for generating a levels-of-detail model. The method includes: performing mesh simplification on a target model to obtain a top-level mesh model; determining remaining-level mesh models based on the top-level mesh model and preset model parameters by a mesh subdivision algorithm, and recording a subdivision parent-child relationship between an upper-level model and a lower-level mesh model; performing texture mapping on a bottom-level mesh model to obtain a bottom-level texture model, wherein the bottom-level mesh model is a bottom-level mesh model of the remaining-level mesh models; determining a levels-of-detail model based on the mesh subdivision parent-child relationship and the bottom-level texture model. The levels-of-detail model constructed by the embodiments has a texture map with unchanged geometric precision and clearer texture details level by level, and the unchanged geometric precision causes to avoid occurring of seam defects.

### CROSS-REFERENCE TO RELATED APPLICATIONS

This application claims the benefit of Chinese patent application No. 202211700543.5 filed on Dec. 29, 2022, the contents of which are incorporated herein by reference.

### TECHNICAL FIELD

The present disclosure relates to the field of data processing technology, and in particular to a method, apparatus, electronic device and storage medium for generating a levels-of-detail model.

### BACKGROUND

Levels Of Detail (LOD) technology is a technology for accelerating model rendering. It may determine the resource allocation for object rendering based on a distance between a camera and an object during rendering, thereby reducing the polygon count and details of non-important objects. Therefore, the generation of a LOD model usually requires simplifying the model to varying degrees, which involves simplifying both geometric details and texture details simultaneously.

In the related art, LOD models are often generated by simplifying geometric details while compressing textures accordingly. However, this approach may lead to seam defects at the boundaries between adjacent patches of different levels due to inconsistencies in geometric precision. The adjacent positions of patches at different levels will have seam defects due to inconsistent precision of the geometric model. Since there are a large number of plane structures in indoor scenes, the model itself may be expressed by using fewer polygons. During rendering, the geometric primitives are minimal, while texture maps primarily occupy memory and rendering time. Therefore, applying LOD only to texture maps achieves better effects and avoids seam defects caused by inconsistent precision of the geometric model. The present disclosure provides an LOD model generation solution that leverages the planar characteristics of indoor scenes and prioritizes texture map LOD.

### SUMMARY

A technical problem to be solved by embodiments of the present disclosure is to provide a method, apparatus, electronic device and storage medium for generating a levels-of-detail model.

According to an aspect of the present disclosure, a method for generating a levels-of-detail model is provided, which includes: performing mesh simplification on a target model to obtain a top-level mesh model; determining remaining-level mesh models based on the top-level mesh model and preset model parameters by a mesh subdivision algorithm, and recording a subdivision parent-child relationship between an upper-level model and a lower-level mesh model; performing texture mapping on a bottom-level mesh model to obtain a bottom-level texture model, wherein the bottom-level mesh model is a bottom-level mesh model of the remaining-level mesh models; and determining a levels-of-detail model based on the mesh subdivision parent-child relationship and the bottom-level texture model.

In an embodiment of the present disclosure, the method further includes: determining an edge length threshold of mesh triangle of any level mesh model based on the preset model parameters.

In another embodiment of the present disclosure, the determining the remaining-level mesh models based on the top-level mesh model and the preset model parameters by the mesh subdivision algorithm includes: performing downward mesh subdivision from the top-level mesh model based on the edge length threshold of the mesh triangle of any level mesh model by the mesh subdivision algorithm to obtain the remaining-level mesh models.

In another embodiment of the present disclosure, the method further includes: dividing the mesh triangle of any level mesh model into at least one patch based on a root node through the subdivision parent-child relationship.

In yet another embodiment of the present disclosure, the performing texture mapping on the bottom-level mesh model to obtain the bottom-level texture model includes: performing texture mapping on the bottom-level mesh model per the at least one patch by a preset texture mapping algorithm to obtain a bottom-level texture map file.

In another embodiment of the present disclosure, the determining the levels-of-detail model based on the mesh subdivision parent-child relationship and the bottom-level texture model includes: determining a sub-triangle in the bottom-level mesh model corresponding to the mesh triangle in the upper-level mesh model based on the subdivision parent-child relationship; determining texture coordinates of the mesh triangle in the upper-level mesh model based on texture coordinates of the sub-triangle; determining an upper-level texture model based on the texture coordinates of the mesh triangle in the upper-level mesh model and the bottom-level texture map file; and generating the levels-of-detail model by texture rearrangement of the upper-level texture model and the bottom-level texture model.

According to a second aspect of the present disclosure, an apparatus for generating a levels-of-detail model is provided, which includes: a mesh simplification module configured to perform mesh simplification on a target model to obtain a top-level mesh model; a mesh subdivision module configured to determine remaining-level mesh models based on the top-level mesh model and preset model parameters by a mesh subdivision algorithm, and record a subdivision parent-child relationship between the upper-level model and the lower-level mesh model; a texture mapping module configured to perform texture mapping on a bottom-level mesh model to obtain a bottom-level texture model, wherein the bottom-level mesh model is a bottom-level mesh model of the remaining-level mesh models; and a texture model determination module configured to determine a levels-of-detail model based on the mesh subdivision parent-child relationship and the bottom-level texture model.

In an embodiment of the present disclosure, the device further includes: a parameter determination module configured to determine an edge length threshold of a mesh triangle of any level mesh model based on the preset model parameters.

In another embodiment of the present disclosure, the mesh subdivision module is configured to perform downward mesh subdivision from the top-level mesh model based on the edge length threshold of the mesh triangle of any level mesh model by the mesh subdivision algorithm to obtain the remaining-level mesh models.

In yet another embodiment of the present disclosure, the device further includes: an image patch division module configured to divide a mesh triangle in any level mesh model into at least one patch based on a root node through the subdivision parent-child relationships.

In yet another embodiment of the present disclosure, the texture mapping module is configured to perform texture mapping on the bottom-level mesh model per the at least one patch by a preset texture mapping algorithm to obtain a bottom-level texture map file.

In yet another embodiment of the present disclosure, the texture model determination module includes: a first determination sub-module configured to determine a sub-triangle in the bottom-level mesh model corresponding to the mesh triangle in the upper-level mesh model based on the mesh subdivision parent-child relationship; a second determination sub-module configured to determine texture coordinates of the mesh triangle in the upper-level mesh model based on texture coordinates of the sub-triangle; a third determination sub-module configured to determine an upper-level texture model based on the texture coordinates of the mesh triangle in the upper-level mesh model and the bottom-level texture map file; a generation sub-module configured to generate the levels-of-detail model by texture rearrangement of the upper-level texture model and the bottom-level texture model.

According to a third aspect of the present disclosure, an electronic device is provided, which includes: a memory configured to store a computer product; and a processor configured to execute the computer product stored in the memory, where the computer product, when executed, causes the processor to perform the above method for generating the levels-of-detail model.

According to a fourth aspect of the present disclosure, a non-transitory computer-readable storage medium storing computer instructions is provided, When the computer instructions are executed by a processor, the above method for generating a levels-of-detail model is performed.

According to a fifth aspect of the present disclosure, a computer program product including computer program instructions is provided. When the computer program instructions are executed by a processor, the above method for generating a levels-of-detail model is performed.

Based on the method, the electronic device, and the storage medium for generating the levels-of-detail model provided by the above embodiments of the present disclosure, a top-level mesh model is obtained by performing mesh simplification on the target model, and then based on the top-level mesh model, a mesh subdivision algorithm is used to determine the remaining level mesh models, that is, a mesh pyramid is successfully constructed, and then the mesh model with the mesh pyramid is texture mapped to obtain the levels-of-detail model. The embodiments of the present disclosure first simplify the target model to the greatest extent to obtain the top-level mesh model, and then apply a mesh subdivision algorithm that does not change the geometric precision to successfully construct a mesh pyramid. During texture mapping being performed on the mesh pyramid, texture mapping is first performed on the bottom-level mesh model subjected to mesh subdivision to obtain a bottom-level texture model. Based on the subdivision parent-child relationships between the mesh pyramids obtained by mesh subdivision, levels-of-detail models with different texture resolutions can be obtained. The levels-of-detail model constructed by the embodiments of the present disclosure has a texture map with unchanged geometric precision and clearer texture details level by level, and the unchanged geometric precision causes to avoid occurring of seam defects.

The technical solutions of the present disclosure are further described in detail below through the accompanying drawings and embodiments.

### BRIEF DESCRIPTION OF THE DRAWINGS

The accompanying drawings, which constitute a part of the specification, illustrate embodiments of the present disclosure and, together with the description, serve to explain the principles of the present disclosure.

The present disclosure can be more clearly understood from the following detailed description with reference to the accompanying drawings, in which:

FIG. 1 is a flow chart of a method for generating a levels-of-detail model according to an embodiment of the present disclosure;

FIG. 2A is a flow chart of a method for generating a levels-of-detail model according to another embodiment of the present disclosure;

FIG. 2B is a schematic diagram of performing mesh simplification on a target model according to the present disclosure;

FIG. 2C is a schematic diagram of the effect of performing mesh subdivision on the upper-level mesh model of the present disclosure;

FIG. 2D is a schematic diagram of the effect of performing texture mapping on a mesh model according to the present disclosure;

FIG. 3 is a flow chart of texture mapping in the method for generating a levels-of-detail model disclosed in the present disclosure;

FIG. 4 is a structural schematic diagram of an apparatus for generating a levels-of-detail model according to an embodiment of the present disclosure;

FIG. 5 is a structural schematic structural diagram of an apparatus for generating a levels-of-detail model according to another embodiment of the present disclosure;

FIG. 6 is a structural diagram of an electronic device according to an exemplary embodiment of the present disclosure.

### DESCRIPTION OF THE PREFERRED EMBODIMENTS

Various exemplary embodiments of the present disclosure will now be described in detail with reference to the accompanying drawings. It should be noted that the relative arrangement of components and steps, numerical expressions and numerical values set forth in these embodiments do not limit the scope of the present disclosure unless otherwise specifically stated.

In addition, it should be understood that for the convenience of description, the sizes of the various parts illustrated in the drawings are not drawn according to the actual proportional relationship.

The following description of at least one exemplary embodiment is merely illustrative in nature and is in no way intended to limit the present disclosure, its application, or uses.

Technologies, methods, and devices known to ordinary skilled in the relevant art may not be discussed in detail, but where appropriate, the technologies, methods, and equipment should be considered as part of the specification.

It should be noted that like reference numerals and letters refer to similar items in the following figures, and therefore, once an item is defined in one figure, it need not be further discussed in subsequent figures.

The embodiments of the present disclosure can be applied to electronic devices such as computer systems/servers, which can operate with many other general or special computing system environments or configurations. Examples of well-known computing systems, environments and/or configurations suitable for use with electronic devices such as computer systems/servers include, but are not limited to: personal computer systems, server computer systems, thin clients, thick clients, handheld or laptop devices, microprocessor-based systems, set-top boxes, programmable consumer electronics, network personal computers, small computer systems, large computer systems, and distributed cloud computing technology environments including any of the above systems, etc.

Computer systems/servers and other electronic devices may be described in the general context of computer system executable instructions (such as program modules) executed by a computer system. In general, program modules may include routines, programs, object programs, components, logic, data structures, etc., which perform specific tasks or implement specific abstract data types. Computer systems/servers may be implemented in a distributed cloud computing environment, where tasks are performed by remote processing devices linked through a communication network. In a distributed cloud computing environment, program modules may be located on local or remote computing system storage media including storage devices.

### Overview of the Disclosure

The technical solution provided by the embodiments of the present disclosure is used for generating LOD models in indoor scenes with a large number of plane structures. Due to the presence of a large number of plane structures, the model itself can be expressed by using fewer polygons. While maintaining the geometric precision unchanged, the seam defect caused by loading LOD patches of different levels during the display process can also be avoided. Therefore, the embodiments of the present disclosure provide a method of first simplifying the mesh of the target model to an extremely simple extent to obtain a top-level mesh model, and then reversely generating the remaining level mesh models by mesh subdivision so that the geometric precision of each level remains unchanged. During performing texture mapping, texture maps with different resolutions and clear texture details can be generated for each level according to the refined parent-child relationship.

### Exemplary Embodiments

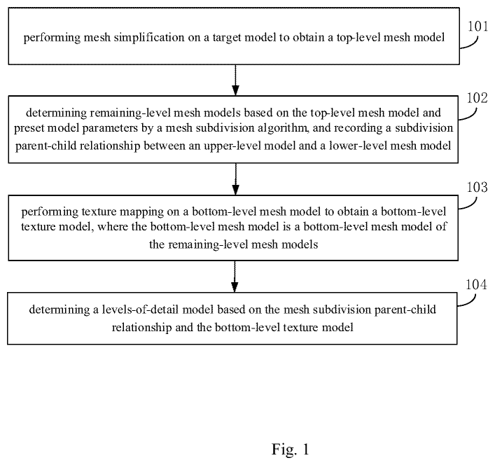

FIG. 1 is a flow chart of a method for generating a levels-of-detail model according to an embodiment of the present disclosure; the method for generating the levels-of-detail model can be applied to an electronic device. As shown in FIG. 1, the method for generating the levels-of-detail model includes the following steps.

In step 101, mesh simplification is performed on the target model to obtain a top-level mesh model.

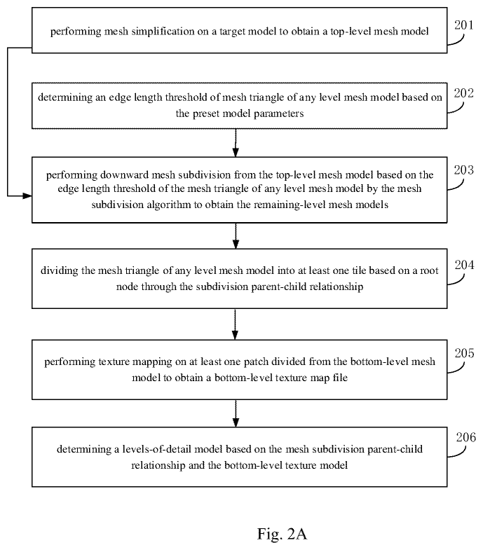

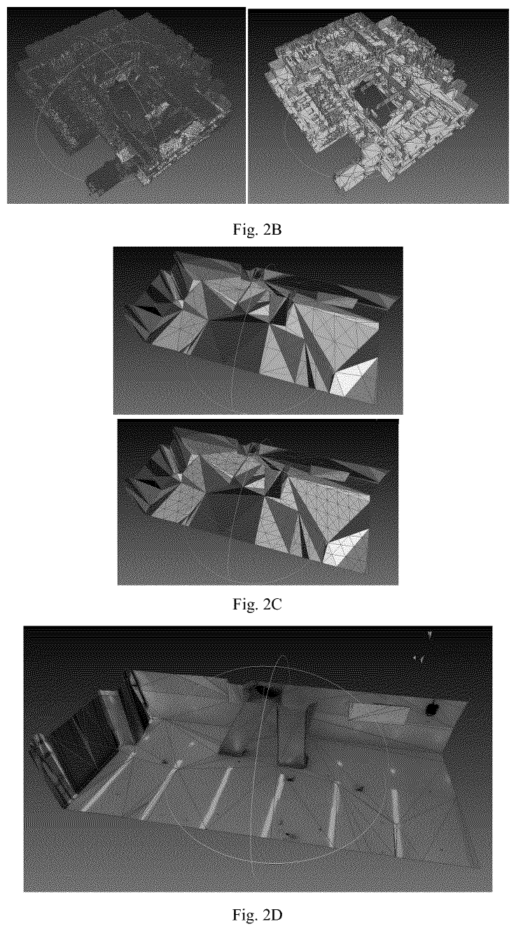

In an embodiment, mesh simplification can be achieved by using an edge collapse simplification algorithm, which is a type of geometric element deletion method and is not described in detail here. It should be noted that for indoor scenes, there is a large amount of plane information, and it has high simplification rate of mesh simplification by using the edge collapse simplification algorithm. Referring to FIG. 2B, it illustrates an effect diagram of performing mesh simplification on the target model. The left graphic in the figure contains approximately two million polygons, while the right graphic in the figure after performing mesh simplification contains approximately one hundred thousand polygons, and thus an overall simplification rate is high. After performing mesh simplification on the target model in the embodiment, it may obtain a highly simplified model (i.e., a top-level mesh model).

In step 102, it may determine remaining-level mesh models based on the top-level mesh model and preset model parameters by a mesh subdivision algorithm, and record a subdivision parent-child relationship between an upper-level model and a lower-level mesh model.

In an embodiment, after the target model is mesh-simplified, the top-level mesh model may be further subdivided by a mesh subdivision algorithm to construct a pyramid model. The geometric precision of each level mesh model in the pyramid model constructed by the mesh subdivision algorithm may remain unchanged. See FIG. 2C, it illustrates an effect diagram of performing mesh subdivision on the upper-level mesh model. The right graphic in the figure is obtained by performing mesh subdivision on the left graphic in the figure. The mesh subdivision is to adapt to the subsequent texture mapping. The image used for texture mapping is not capable of covering the entire scene. Each image only covers a part of the scene. When the top-level mesh triangle obtained by performing mesh simplification on the target model has a large triangle, if the mesh is not subdivided, it is likely that no image can cover the whole triangle, and thus it may occur a problem of inability to perform effective texture mapping.

In an embodiment, the preset model parameters may be the number of model levels, for example, the pyramid model to be constructed may be set as a three-level pyramid. In an embodiment, the pyramid model may also be set as a model tree, for example, a quadtree or an octree, and the number of levels of the pyramid model can also be determined based on a size of the leaf node. In an embodiment, the preset model parameters may also include an edge length threshold of mesh triangle of each level mesh model. For example, the edge length threshold of the mesh triangle of the top-level model is 1 m, then the edge length threshold of the mesh triangle of each lower-level model is the edge length threshold of the mesh triangle of the upper-level model divided by 2.

In an embodiment, the number of model levels of the pyramid model and the edge length threshold of the mesh triangle of any level mesh model are determined based on the preset model parameters, and the mesh subdivision algorithm may be used to perform downward mesh subdivision from the top-level mesh model, so that the edge length of each triangle in the current level mesh is not greater than the edge length threshold of the mesh triangle, thereby obtaining the remaining level mesh models.

In an embodiment, the mesh subdivision may be simply performed by using a quad-splitting algorithm (dividing one into four), or a longest-edge bisection strategy (splitting the longest edge into two). If the pyramid model has a total of n levels, ranging from [0, n-1], then the (n-1)^{th} level represents the most subdivided bottom-level mesh model, the 0^{th} level represents the simplified top-level mesh model, the 1^{st} level is subdivided from the 0^{th} level model, the 2^{nd} level is subdivided from the 1^{st} level model, and so on, the lower-level is subdivided from the upper-level model. The remaining level mesh models refer to the lower-level models excluding the top-level mesh model.

In an embodiment, when the mesh is subdivided, it is also need to record the subdivision parent-child relationship between the upper-level mesh model and the lower-level mesh model, that is, to record which mesh triangle of the upper-level mesh model the mesh triangle of the lower-level mesh model is subdivided from.

In step 103, texture mapping is performed on the bottom-level mesh model to obtain a bottom-level texture model, where the bottom-level mesh model is a bottom-level mesh model in the remaining level mesh models.

In an embodiment, based on the mesh subdivision parent-child relationship, the bottom-level mesh model is divided into at least one patch, and then texture expansion and texture mapping are performed per the patches to obtain the bottom-level texture model.

It should be noted that the texture coordinates of the vertices of each mesh triangle in the bottom-level mesh model are normalized. By performing texture mapping per the divided patches, it can be ensured that the corresponding texture coordinates of triangles having the same root node are spatially continuous in the texture map.

In step 104, a levels-of-detail model is determined based on the mesh subdivision parent-child relationship and the bottom-level texture model.

In an embodiment, based on the corresponding subdivision relationship between the mesh triangles in the upper-level mesh model and the lower-level mesh model, and the texture coordinates of the vertices of the lower-level mesh model, the texture coordinates of the vertices of the upper-level mesh triangles can be directly obtained, which are also normalized. As the normalization of the texture coordinates, the texture map of the bottom-level texture model can be directly scaled to obtain the texture map of the upper-level mesh model.

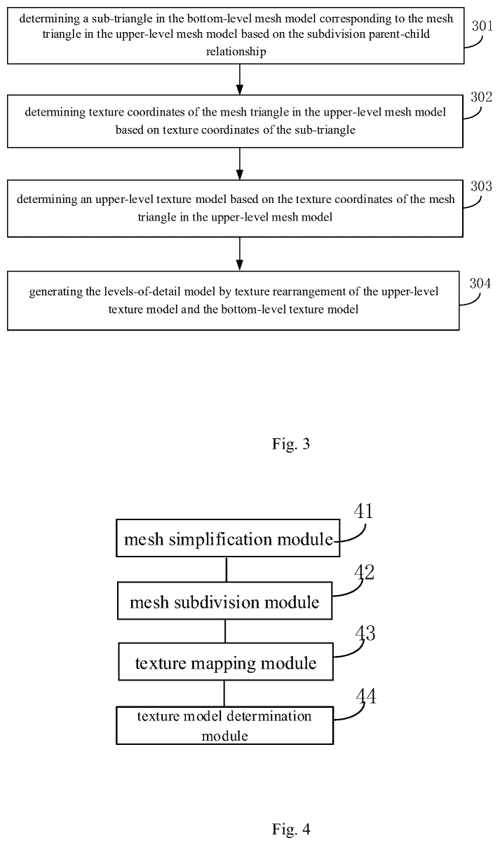

In an embodiment, the implementation of determining the levels of detail model based on the mesh subdivision parent-child relationship and the bottom-level texture model can be referred to the embodiment shown in FIG. 3, which is not described in detail here.

In the above steps 101 to 104, a top-level mesh model is obtained by performing mesh simplification on the target model, and then based on the top-level mesh model, a mesh subdivision algorithm is used to determine the remaining level mesh models, that is, a mesh pyramid is successfully constructed, and then the mesh model with the mesh pyramid is texture mapped to obtain the levels-of-detail model. The embodiments of the present disclosure first simplify the target model to the greatest extent to obtain the top-level mesh model, and then apply a mesh subdivision algorithm that does not change the geometric precision to successfully construct a mesh pyramid. During texture mapping being performed on the mesh pyramid, texture mapping is first performed on the bottom-level mesh model subjected to mesh subdivision to obtain a bottom-level texture model. Based on the subdivision parent-child relationships between the mesh pyramids obtained by mesh subdivision, levels-of-detail models with different texture resolutions can be obtained. The levels-of-detail model constructed by the embodiments of the present disclosure has a texture map with unchanged geometric precision and clearer texture details level by level, and the unchanged geometric precision causes to avoid occurring of seam defects.

In order to better illustrate the method for generating the levels-of-detail model of the present disclosure, another embodiment is used below for illustration.

FIG. 2A is a flow chart of a method for generating a levels-of-detail model of according to another embodiment of the present disclosure, FIG. 2B is a schematic diagram of performing mesh simplification on a target model according to the present disclosure, FIG. 2C is a schematic diagram of the effect of performing mesh subdivision on the upper-level mesh model of the present disclosure, and FIG. 2D is a schematic diagram of the effect of performing texture mapping on a mesh model according to the present disclosure. This embodiment is exemplarily described by taking how to generate a levels-of-detail model as an example, as shown in FIG. 2A, which includes the following steps.

In step 201, mesh simplification is performed on the target model to obtain a top-level mesh model.

In an embodiment, after mesh simplification is performed on the target model, step 203 is performed.

In step 202, the edge length threshold of the mesh triangle of any level mesh model is determined based on the preset model parameters.

In an embodiment, the preset model parameters may be the number of model levels, for example, the pyramid model to be constructed may be set as a three-level pyramid. In an embodiment, the pyramid model may also be set as a model tree, for example, a quadtree or an octree, and the number of levels of the pyramid model can also be determined based on a size of the leaf node. In an embodiment, the preset model parameters may also include an edge length threshold of mesh triangle of each level mesh model. For example, the edge length threshold of the mesh triangle of the top-level model is 1 m, then the edge length threshold of the mesh triangle of each lower-level model is the edge length threshold of the mesh triangle of the upper-level model divided by 2.

In step 203, based on the edge length threshold of the mesh triangle of any level of mesh model, the mesh subdivision algorithm is used to perform downward mesh subdivision from the top-level mesh model to obtain the remaining level mesh models.

In an embodiment, the mesh subdivision may be simply performed by using a quad-splitting algorithm (dividing one into four), or a longest-edge bisection strategy (splitting the longest edge into two). If the pyramid model has a total of n levels, ranging from [0, n-1], then the (n-1)^{th} level represents the most subdivided bottom-level mesh model, the 0^{th} level represents the simplified top-level mesh model, the 1^{st} level is subdivided from the 0^{th} level model, the 2^{nd} level is subdivided from the 1^{st} level model, and so on, the lower-level is subdivided from the upper-level model. The remaining level mesh models refer to the lower-level models excluding the top-level mesh model. When performing mesh subdivision, it needs to ensure that the edge length of each triangle in the current level mesh is not greater than the edge length threshold of the mesh triangle, so as to obtain the remaining level mesh model.

In step 204, based on the subdivided parent-child relationship, the mesh triangles in any level mesh model are divided into at least one patch based on the root node.

In an embodiment, when performing mesh subdivision from the top-level mesh model to the lower-levels, it needs to record a sub-triangle in the bottom-level mesh model corresponding to each mesh triangle, and divide the mesh triangles in any level mesh model into at least one patch based on the root node. For example, it may perform mesh subdivision on mesh triangle 1 in the top-level (0^{th} level) mesh model to obtain the first-level mesh triangles “11, 12, 13, 14”. The first-level mesh triangles “11, 12, 13, 14” share the same root node, so they are grouped into one patch. When continuing to be subdivided into the next level, the second-level mesh triangles “111, 112, 113, 114, 121, 122, 123, 124, 131, 132, 133, 134, 141, 142, 143, 144” can be obtained accordingly, and the second-level mesh triangles “111, 112, 113, 114, 121, 122, 123, 124, 131, 132, 133, 134, 141, 142, 143, 144” share the same root node and are grouped into one patch.

In step 205, texture mapping is performed on at least one patch divided in the bottom-level mesh model to obtain an bottom-level texture model.

In an embodiment, any texture mapping algorithm may be used to obtain the texture coordinates of any mesh triangle in the bottom-level mesh model, and texture mapping is performed to obtain the bottom-level texture map file. The bottom-level texture map file is one or a bunch of images, and the mesh triangle has some additional attribute information, including the vertices of each mesh triangle, which texture image the map comes from, and the vertex coordinates of the mesh triangle.

In implementation, texture expansion may be performed based on the patches divided in step 204, and then texture mapping may be performed based on at least one of the divided patches, so that the texture coordinates of the same patch obtained are also continuous on the image.

In step 206, a levels-of-detail model is determined based on the mesh subdivision parent-child relationship and the bottom-level texture model.

In an embodiment, the implementation method of determining the levels of detail model based on the mesh subdivision parent-child relationship and the bottom-level texture model can be referred to the embodiment shown in FIG. 3, which is not described in detail here.

Through the above steps 201 to 206, this embodiment discloses an implementation of mesh subdivision, and subsequent effective texture mapping can be achieved through mesh subdivision, which ensures that the levels of detail model constructed by the embodiment of the present disclosure has a texture map with unchanged geometric precision and clear texture details level by level, and the unchanged geometric precision can avoid occurring of seam defects.

FIG. 3 is a flow chart of a method for generating a levels-of-detail model according to an embodiment of the present disclosure; this embodiment is exemplified by how to generate a levels-of-detail model based on the bottom-level texture model and the mesh subdivision parent-child relationship. As shown in FIG. 3, the method includes the following steps.

In step 301, a sub-triangle in the bottom-level mesh model corresponding to the mesh triangle in the upper-level mesh model is determined based on the subdivision parent-child relationship.

In an embodiment, the vertices of the corresponding sub-triangles in the lower-level mesh model may be obtained based on the mesh triangles in the upper-level mesh model and the mesh subdivision parent-child relationship.

In step 302, the texture coordinates of the mesh triangle in the upper-level mesh model are determined based on the texture coordinates of the sub-triangle.

In an embodiment, when texture mapping is performed on the bottom-level mesh model, the texture coordinates of the mesh triangles are obtained. The texture coordinates of the vertices of the upper-level mesh triangles can be directly obtained based on the subdivision relationship between the mesh triangles in the upper-level mesh model and the lower-level mesh model, and the texture coordinates of the vertices of the lower-level mesh model.

In step 303, an upper-level texture model is determined based on texture coordinates of mesh triangles in the upper-level mesh model.

In steps 302 to 303, the texture coordinates of the vertices of each mesh triangle in the bottom-level mesh model are generally normalized. Therefore, the texture coordinates of the vertices of the upper-level mesh triangle can be directly obtained based on the subdivision relationship between the mesh triangles in the upper-level mesh model and the lower-level mesh model, and the texture coordinates of the vertices of the lower-level mesh model. The obtained texture coordinates of the vertices of the upper-level mesh triangle are also normalized. As the normalization of the texture coordinates, the texture map of the bottom-level texture model can be directly scaled to obtain the texture map of the upper-level mesh model.

In step 304, the upper-level texture model and the bottom-level texture model are texture rearranged to generate the levels of detail model.

In an embodiment, the texture rearrangement technology may be used to rearrange the texture of the upper-level texture model and the bottom-level texture model. During the rearrangement process, the texture image can be reduced in size and the resolution can be reduced to generate a levels of detail model, which is a levels of detail model of the texture. Referring to FIG. 2D, it illustrates the effect of performing texture mapping on the mesh model. It can be seen that the rendering effect achieved according to the technical solution of the present disclosure has a simplified texture leveling while avoiding occurring of seam defects.

Through the above steps 301 to 304, during performing the texture mapping in this embodiment, the sub-triangles of the mesh triangles in the top-level mesh model sharing the same root node are all in one map file, which ensures that the texture is continuous. Furthermore, the model which has been performed the upper-level texture mapping may be efficiently retrieved by simply querying the corresponding relationship. Through texture rearrangement, the generated levels of detail model maintains unchanged geometric precision and simplified texture leveling, which not only ensures the effect of the levels of detail model, but also improves the rendering efficiency.

Corresponding to the above-mentioned embodiment of the method for generating the levels-of-detail model, the present disclosure also provides corresponding embodiments of the apparatus for generating the levels-of-detail model.

FIG. 4 is a structural schematic diagram of an apparatus for generating a levels-of-detail model according to an embodiment of the present disclosure. The apparatus is applied to an electronic device. As shown in FIG. 4, the apparatus includes: a mesh simplification module 41, which is configured to perform mesh simplification on a target model to obtain a top-level mesh model; a mesh subdivision module 42, which is configured to determine remaining-level mesh models based on the top-level mesh model and preset model parameters by a mesh subdivision algorithm, and record a subdivision parent-child relationship between the upper-level model and the lower-level mesh model; a texture mapping module 43, which is configured to perform texture mapping on a bottom-level mesh model to obtain a bottom-level texture model, wherein the bottom-level mesh model is a bottom-level mesh model of the remaining-level mesh models; and a texture model determination module 44, which is configured to determine a levels-of-detail model based on the mesh subdivision parent-child relationship and the bottom-level texture model.

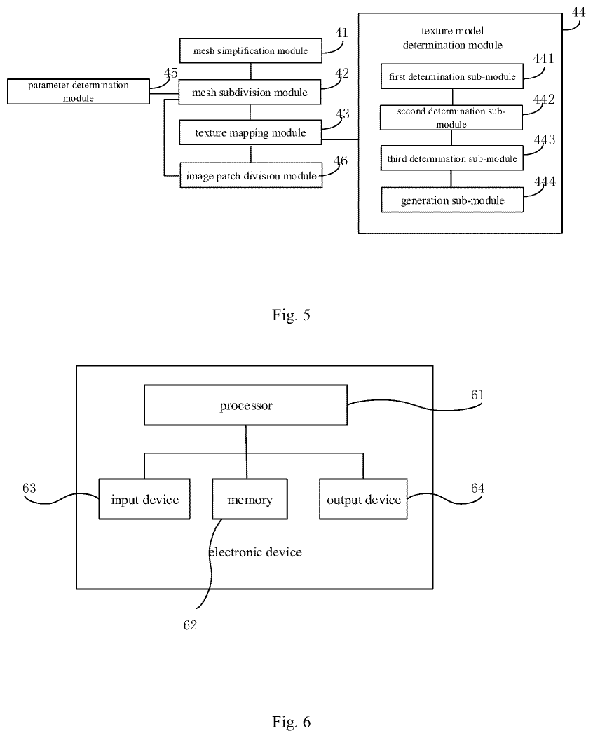

FIG. 5 is a structural schematic diagram of the apparatus for generating a levels-of-detail model according to another embodiment of the present disclosure. As shown in FIG. 4, based on the embodiment shown in FIG. 4, the apparatus further includes a parameter determination module 45 configured to determine an edge length threshold of a mesh triangle of any level mesh model based on the preset model parameters.

In an embodiment, the mesh subdivision module 42 is configured to perform downward mesh subdivision from the top-level mesh model based on the edge length threshold of the mesh triangles of any level of mesh model by the mesh subdivision algorithm to obtain the remaining level mesh models.

In an embodiment, the apparatus further includes an image patch division module 46 configured to divide a mesh triangle in any level mesh model into at least one patch based on a root node through the subdivision parent-child relationships.

In an embodiment, the texture mapping module 43 is configured to perform texture mapping on the bottom-level mesh model per the at least one patch by a preset texture mapping algorithm to obtain a bottom-level texture map file.

In an embodiment, the texture model determination module 44 includes: a first determination sub-module 441, which is configured to determine a sub-triangle in the bottom-level mesh model corresponding to the mesh triangle in the upper-level mesh model based on the mesh subdivision parent-child relationship; a second determination sub-module 442, which is configured to determine texture coordinates of the mesh triangle in the upper-level mesh model based on texture coordinates of the sub-triangle; a third determination submodule 443, which is configured to determine an upper-level texture model based on the texture coordinates of the mesh triangle in the upper-level mesh model and the bottom-level texture map file; and a generation sub-module 444, which is configured to generate the levels-of-detail model by texture rearrangement of the upper-level texture model and the bottom-level texture model.

The implementation of the functions of each module in the above-mentioned apparatus is described in detail in the implementation of the corresponding steps in the above-mentioned method, which is not repeated here.

For the apparatus embodiments, since they basically correspond to the method embodiments, the relevant parts can refer to the partial description of the method embodiments. The apparatus embodiments described above are merely exemplary, where the units described as separate components may or may not be physically separated, and the components displayed as units may or may not be physical units, that is, they may be located in one place, or they may be distributed on multiple network units. Some or all of the modules may be selected based on actual requirements to achieve the purpose of the disclosed solution. A person of ordinary skill in the art may understand and implement it without creative work.

An electronic device according to an embodiment of the present disclosure is described with reference to FIG. 6, in which a device for implementing the method of embodiments of the present disclosure may be integrated. FIG. 6 is a structural diagram of an electronic device provided by an illustrative embodiment of the present disclosure. As shown in FIG. 6, the electronic device includes one or more processors 61, and one or more computer-readable memory 62 storing computer programs which are executable by the processor. When executing the programs in the memory 62, the above-mentioned method for generating the levels-of-detail model may be implemented.

In practical applications, the electronic device may further include components such as an input device 63 and an output device 64, and these components are interconnected via a bus system and/or other forms of connection mechanisms (not shown). Those skilled in the art would appreciate that the structure of the electronic device shown in FIG. 6 does not constitute a limitation on the electronic device, and may include more or fewer components than shown, or some components, or different component arrangements.

The processor 61 may be a central processing unit (CPU) or other forms of processing units which have data processing capabilities and/or instruction execution capabilities, and control other components in the electronic device to perform desired functions.

The memory 62 can store one or more computer program products, and the memory can include various forms of computer-readable storage media, such as volatile memory and/or non-volatile memory. Volatile memory can include, for example, random access memory (RAM) and/or cache memory (cache), etc. Non-volatile memory can include, for example, read-only memory (ROM), hard disk, flash memory, etc. One or more computer program products can be stored on a non-transitory computer-readable storage medium, and the processor 61 can run the computer program product to implement the above-mentioned method for generating a levels-of-detail model of each embodiment of the present disclosure and/or other desired functions.

In an example, the electronic device may further include: an input device 63 and an output device 64, which are interconnected via a bus system and/or other forms of connection mechanisms (not shown). In addition, the input device 63 may include, for example, a keyboard, a mouse, and the like.

The output device 64 can output various information to the outside, including the determined distance information, direction information, etc. The output device 64 can include, for example, a display, a speaker, a printer, a communication network and a remote output device connected thereto, and the like.

For simplicity, FIG. 6 only illustrates some of the components in the electronic device related to the present disclosure, omitting components such as a bus, an input/output interface, etc. In addition, the electronic device may further include any other appropriate components according to specific application scenarios.

In addition to the above-mentioned methods and devices, an embodiment of the present disclosure may also be a computer program product, which includes computer program instructions, which, when executed by a processor, enable the processor to execute the steps in the method according to various embodiments of the present disclosure.

The computer program product may be written in any combination of one or more programming languages to write program code for performing the operations of the disclosed embodiments, including object-oriented programming languages such as Java, C++, etc., and conventional procedural programming languages such as “C” or similar programming languages. The program code may be executed entirely on the user computing device, partially on the user device, as a separate software package, partially on the user computing device and partially on a remote computing device, or entirely on a remote computing device or server.

In addition, an embodiment of the present disclosure may also be a non-transitory computer-readable storage medium having computer program instructions stored thereon, which, when executed by a processor, enable the processor to execute the steps of the method for generating a levels-of-detail model according to various embodiments of the present disclosure.

The non-transient computer readable storage medium can adopt any combination of one or more readable media. The readable medium can be a readable signal medium or a readable storage medium. The readable storage medium can include, for example, but is not limited to, a system or device of electricity, magnetism, light, electromagnetic, infrared, or semiconductor, or any combination of the above. More specific examples (non-exhaustive list) of readable storage media include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The basic principles of the present disclosure are described above in conjunction with embodiments. However, it should be noted that the advantages, effects mentioned in the present disclosure are only exemplary and not limitations, and it cannot be considered that these advantages, effects must be possessed by each embodiment of the present disclosure. In addition, the specific details disclosed above are only for the purpose of illustration and ease of understanding, rather than limitation, and the above details do not limit the present disclosure to the necessity of adopting the above specific details to be implemented.

Each embodiment in this specification is described in a progressive manner, and each embodiment focuses on the differences from other embodiments. The same or similar parts between the embodiments can be referred to each other. For the system embodiment, since it basically corresponds to the method embodiment, the description is relatively simple, and the relevant parts can be referred to the partial description of the method embodiment.

A person of ordinary skill in the art can understand that all or part of the steps of implementing the above method embodiment can be completed by hardware related to program instructions, and the aforementioned program can be stored in a computer-readable storage medium. When the program is executed, it executes the steps of the above method embodiment; and the aforementioned storage medium includes: ROM, RAM, magnetic disk or optical disk, etc., various media that can store program codes.

The method and apparatus of the present disclosure may be implemented in many ways. For example, the method and apparatus of the present disclosure may be implemented by software, hardware, firmware, or any combination of software, hardware, and firmware. The above order of steps for the method is for illustration only, and the steps of the method of the present disclosure are not limited to the order specifically described above unless otherwise specified. In addition, in some embodiments, the present disclosure may also be implemented as a program recorded in a recording medium, which includes machine-readable instructions for implementing the method according to the present disclosure. Thus, the present disclosure also covers a recording medium storing a program for executing the method according to the present disclosure.

The description of the present disclosure is given for the purpose of illustration and description, and is not intended to be exhaustive or to limit the present disclosure to the disclosed form. Many modifications and variations will be apparent to those of ordinary skill in the art. The embodiments are selected and described in order to better illustrate the principles and practical applications of the present disclosure, and to enable those of ordinary skill in the art to understand the present disclosure and thereby design various embodiments with various modifications suitable for specific uses.

What is claimed is:

1. A method for generating a levels-of-detail model, comprising:
performing mesh simplification on a target model to obtain a top-level mesh model;
determining remaining-level mesh models based on the top-level mesh model and preset model parameters by a mesh subdivision algorithm, and recording a subdivision parent-child relationship between an upper-level model and a lower-level mesh model;
performing texture mapping on a bottom-level mesh model to obtain a bottom-level texture model, wherein the bottom-level mesh model is a bottom-level mesh model of the remaining-level mesh models; and
determining a levels-of-detail model based on the subdivision parent-child relationship and the bottom-level texture model.

2. The method of claim 1, further comprising:
determining an edge length threshold of mesh triangle of any level mesh model based on the preset model parameters.

3. The method of claim 2, wherein the determining the remaining-level mesh models based on the top-level mesh model and the preset model parameters by the mesh subdivision algorithm comprises:
performing downward mesh subdivision from the top-level mesh model based on the edge length threshold of the mesh triangle of any level mesh model by the mesh subdivision algorithm to obtain the remaining-level mesh models.

4. The method of claim 1, further comprising:
dividing the mesh triangle of any level mesh model into at least one patch based on a root node through the subdivision parent-child relationship.

5. The method of claim 4, wherein the performing texture mapping on the bottom-level mesh model to obtain the bottom-level texture model comprises:
performing texture mapping on the bottom-level mesh model per the at least one patch by a preset texture mapping algorithm to obtain a bottom-level texture map file.

6. The method of claim 5, wherein the determining the levels-of-detail model based on the subdivision parent-child relationship and the bottom-level texture model comprises:
determining a sub-triangle in the bottom-level mesh model corresponding to the mesh triangle in the upper-level mesh model based on the subdivision parent-child relationship;
determining texture coordinates of the mesh triangle in the upper-level mesh model based on texture coordinates of the sub-triangle;
determining an upper-level texture model based on the texture coordinates of the mesh triangle in the upper-level mesh model and the bottom-level texture map file; and
generating the levels-of-detail model by texture rearrangement of the upper-level texture model and the bottom-level texture model.

7. An apparatus for generating a levels-of-detail model, comprising:
a mesh simplification module configured to perform mesh simplification on a target model to obtain a top-level mesh model;
a mesh subdivision module configured to determine remaining-level mesh models based on the top-level mesh model and preset model parameters by a mesh subdivision algorithm, and record a subdivision parent-child relationship between the upper-level model and the lower-level mesh model;
a texture mapping module configured to perform texture mapping on a bottom-level mesh model to obtain a bottom-level texture model, wherein the bottom-level mesh model is a bottom-level mesh model of the remaining-level mesh models; and
a texture model determination module configured to determine a levels-of-detail model based on the subdivision parent-child relationship and the bottom-level texture model.

8. The apparatus of claim 7, further comprising:
a parameter determination module configured to determine an edge length threshold of a mesh triangle of any level mesh model based on the preset model parameters.

9. The apparatus of claim 8, wherein the mesh subdivision module is configured to perform downward mesh subdivision from the top-level mesh model based on the edge length threshold of the mesh triangle of any level mesh model by the mesh subdivision algorithm to obtain the remaining-level mesh models.

10. The apparatus of claim 7, further comprising:
an image patch division module configured to divide a mesh triangle in any level mesh model into at least one patch based on a root node through the subdivision parent-child relationships.

11. The apparatus of claim 10, wherein the texture mapping module is configured to perform texture mapping on the bottom-level mesh model per the at least one patch by a preset texture mapping algorithm to obtain a bottom-level texture map file.

12. The apparatus of claim 11, wherein the texture model determination module comprises:
a first determination sub-module configured to determine a sub-triangle in the bottom-level mesh model corresponding to the mesh triangle in the upper-level mesh model based on the subdivision parent-child relationship;
a second determination sub-module configured to determine texture coordinates of the mesh triangle in the upper-level mesh model based on texture coordinates of the sub-triangle;
a third determination sub-module configured to determine an upper-level texture model based on the texture coordinates of the mesh triangle in the upper-level mesh model and the bottom-level texture map file; and
a generation sub-module configured to generate the levels-of-detail model by texture rearrangement of the upper-level texture model and the bottom-level texture model.

13. An electronic device, comprising:
a memory configured to store a computer product; and
a processor configured to execute the computer product stored in the memory, wherein the computer product, when executed, causes the processor to perform the method according to claim 1.

14. (canceled)

15. (canceled)
